(19) United States
(12) Patent Application Publication
(10) Pub. No.: US 2020/0332963 A1
(43) Pub. Date: Oct. 22, 2020

(54) Patch LED light bulb

(71) Applicant: Linlin WU, Fujian (CN)

(72) Inventor: Linlin WU, Fujian (CN)

(21) Appl. No.: 16/526,991

(22) Filed: Jul. 30, 2019

(30) Foreign Application Priority Data
Apr. 22, 2019 (CN) 201920551873.X

(51) Int. Cl. F21K 9/237; F21K 9/232; F21K 9/235; F21K 9/66; F21V 19/00; F21V 23/02

(52) U.S. Cl. CPC F21K 9/237; F21K 9/232; F21K 9/235; F21Y 2115/00; F21V 19/003; F21V 23/02; F21K 9/66

(57) ABSTRACT

The present invention provides a patch LED light bulb comprising a lampshade and a base. It further comprises a light source baseboard and a power supply board which are disposed inside the lampshade and electrically connected to each other. The light source baseboard is pasted or soldered with more than one LED chip. The lampshade comprises a cover body and an assembly portion integrally connected to the cover body. The assembly portion is inserted into the base. A limiting slot is provided on the assembly portion. A positioning slot is provided on the light source baseboard. The power supply board abuts against the light source baseboard and is perpendicular to the light source baseboard. The power supply board is integrally connected with a limiting protrusion for inserting to the limiting slot and a positioning protrusion for inserting the positioning slot.

### BACKGROUND OF THE INVENTION

The present invention relates to light bulbs and more particularly pertains to an LED light bulb.

Conventional light bulbs are usually tungsten light bulbs using tungsten wires as light-emitting components; they are relatively high in power consumption, relatively low in brightness and high in heat emission. Therefore, tungsten light bulbs are gradually replaced by LED light bulbs.

Existing LED light bulbs use only LED filaments or LED chips as light-emitting components. Among them, an LED light bulb using an LED chip as light-emitting component usually requires a light source baseboard (also referred to as a substrate) for receiving the LED chip, and a power supply board to supply power to the light source baseboard. In order to dissipate heat, there is usually a gap between the light source baseboard and the power supply board. Therefore, it is necessary to provide a connecting component between the light source baseboard and the power supply board to achieve secured connection between the light source baseboard and the power supply board, thereby resulting in complicated assembly and relatively high costs.

Besides, lampshades of existing light bulbs are usually made of glass which is vulnerable. Glass lampshades also need to be heated and sintered by an open fire during the manufacturing process. This induces certain safety risks.

In view of the above, the Applicant has conducted in-depth research on the structure of LED light bulbs, thereby devising the present invention.

### BRIEF SUMMARY OF THE INVENTION

It is an object of the present invention to provide a patch LED light bulb that is simple to assemble and relatively low in costs.

To attain this, the present invention adopts the following technical solution:

A patch LED light bulb comprises a lampshade and a base fixedly connected to the lampshade. It further comprises a light source baseboard and a power supply board which are disposed inside the lampshade and electrically connected to each other. The light source baseboard is pasted or soldered with one or more LED chip. The lampshade comprises a cover body and an assembly portion integrally connected to the cover body. The assembly portion is inserted into the base. A limiting slot is provided on the assembly portion. A positioning slot is provided on the light source baseboard. The power supply board abuts against the light source baseboard and is perpendicular to the light source baseboard. The power supply board is integrally connected with a limiting protrusion for inserting to the limiting slot and a positioning protrusion for inserting the positioning slot.

As an improvement of the present invention, the lampshade is a translucent plastic lampshade.

As an improvement of the present invention, a plurality of grooves are provided on an outer surface of the cover body; a plurality of protrusions are provided on an inner surface of the cover body at positions corresponding to the grooves.

As an improvement of the present invention, one end of the assembly portion which is connected with the cover body is integrally connected with a flange. The base abuts against the flange.

As an improvement of the present invention, the light source baseboard is disposed at a position corresponding to the flange inside the assembly portion.

As an improvement of the present invention, a sealant is encapsulated between an outer wall of the assembly portion and an inner wall of the base.

As an improvement of the present invention, the base is a threaded base. An external threaded segment that matches with the threaded base is provided on the assembly portion.

With the above technical solution, the present invention has the following beneficial effects:

1. By providing the positioning slot and the limiting slot, the power supply board is coupled to the positioning slot and the limiting slot by snap connection, resulting in more convenient assembly. Since the power supply board is perpendicular to the light source baseboard, two sides of the power supply board can naturally dissipate heat, thus no additional heat dissipation structure and connection structure is required, resulting in lower costs.

2. Since the lampshade is a translucent plastic lampshade, it is not vulnerable and can be formed by injection molding or blow molding during processing without using an open fire, and hence enhancing production safety.

3. By encapsulating the sealant, the waterproof performance of the light bulb is effectively improved.

4. By providing an external threaded segment on the assembly portion, the connection stability between the lampshade and the base can be improved.

### BRIEF DESCRIPTION OF THE DRAWINGS

FIG. 1 shows a cross-sectional view of a patch LED light bulb of the present invention, in which the cover body and the sealing glue is omitted;

FIG. 2 shows an exploded view of the patch LED light bulb of the present invention.

FIG. 3 is a schematic view showing the position of the sealant in the present invention.

The references in the figures correspond to the following:

10-lampshade; 11-cover body; 12-assembly portion; 12a-outer wall of the assembly portion; 12b-external threaded segment; 13-limiting slot; 14-flange; 15-groove; 20-base; 20a-inner wall of the base; 30-light source baseboard; 31-LED chip; 32-positioning slot; 40-power supply board; 41-limiting protrusion; 42-positioning protrusion; 50-sealant.

### DETAILED DESCRIPTION OF THE INVENTION

The present invention will be further described below in conjunction with the accompanying drawings and specific embodiment.

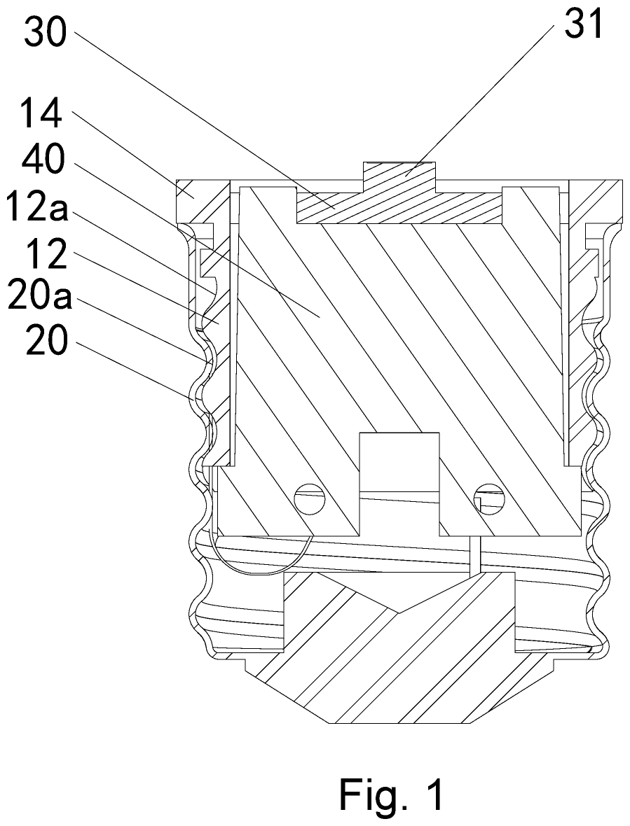

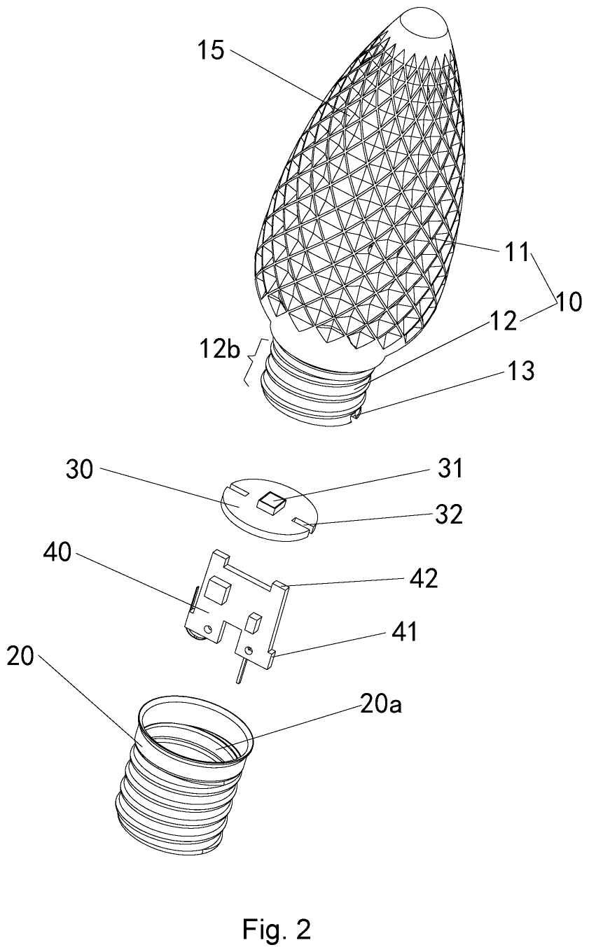

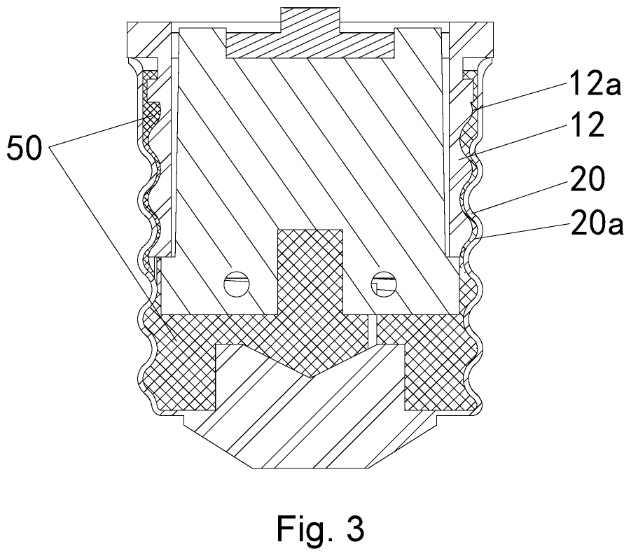

As illustrated in FIGS. 1 to 3, the patch LED light bulb of the present embodiment comprises a lampshade 10, a base 20 fixedly connected to the lampshade 10, a light source baseboard 30 and a power supply board 40 which are disposed inside the lampshade 10 and electrically connected to each other. The lampshade 10 is a translucent plastic lampshade which helps to improve the anti-drop capability of the light bulb and avoids the use of open fire in the manufacturing process (plastic parts can be injection-molded).

The lampshade 10 comprises a cover body 11 and an assembly portion 12 integrally connected to the cover body 11. The cover body 11 has an outer appearance which is identical to the cover body of the lampshade of a conventional tungsten light bulb, and the specific shape can be designed according to actual needs. Preferably, in the present embodiment, a plurality of grooves 15 are evenly provided on an outer surface of the cover body 11; a plurality of protrusions (not shown in the drawings) are provided on an inner surface of the cover body 11 at positions corresponding to the grooves 15, so that when light passes through the cover body 11, refraction is produced and a more beautiful lighting effect could be obtained. The assembly portion 12 has an inner bore for connecting an inner cavity of the cover body and an external space of the cover body. The light source baseboard 30 and the power supply board 40 are located in the inner bore, and the assembly portion 12 is inserted into the base 20. The base 20 is a threaded base used in conventional tungsten filament light bulbs. Its main body is usually pressure formed by a metal sleeve. Therefore, when an external thread of the threaded opening of the base 20 is formed, an internal threaded bore is naturally formed in the interior of the base 20. An external threaded segment 12b that matches with the internal threaded bore of the threaded base is provided on the assembly portion 12. A sealant 50 is encapsulated between an outer wall 12a of the assembly portion 12 and an inner wall 20a of the base 20. In this way, the connection is more secured so that the lampshade 10 and the base 20 are not easily disconnected due to external force when the light bulb is installed, and the waterproof performance of the light bulb is effectively improved. In addition, the assembly portion 12 is provided with limiting slots 13 which connect with the inner bore. Specifically, there are two limiting slots 13. The two limiting slots 13 are oppositely arranged and located on an end surface of the end of the assembly portion 12 which is distant from the cover body 11.

Preferably, in the present embodiment, the end of the assembly portion 12 which is connected to the cover body 11 is integrally connected with a flange 14, that is, the cover body 11 is connected on the flange 14. The base 20 abuts against the flange 14 to form a positioning structure, so that short circuit possibly caused by contact between the bottom of the inner cavity of the base 20 and the power supply board 40 can be prevented.

The light source baseboard 30 interference fits with the inner bore to achieve a fixed connection between the light source baseboard 30 and the assembly portion 12. The light source baseboard 30 is disposed at a position corresponding to the flange 14 inside the assembly portion 12, and is pasted or soldered with one or more LED chip 31 thereon. The LED chip 31 is located on the side of the light source baseboard 30 facing the cover body 11. Besides, a positioning slot 32 is provided on the light source baseboard 30. The positioning slot 32 and the two limiting slots 13 are located on the same surface.

The power supply board 40 may be a power supply board used in a conventional LED light bulb; it abuts against the light source baseboard 30 and is perpendicular to the light source baseboard 30. Preferably, the electrical connection interfaces between the light source baseboard 30 and the power supply board 40 are located on surfaces of the light source baseboard 30 and the power supply board 40 respectively to achieve electrical connection by mutual contact. At the same time, the power supply board 40 is integrally provided with limiting protrusions 41 for inserting to the limiting slots 13 and a positioning protrusion 42 for inserting to the positioning slot 32. The inter-connection between the liming protrusions 41 and the limiting slots 13 enables the connection between the power supply board 40 and the assembly portion 12. The inter-connection between the positioning protrusion 42 and the positioning slot 32 enables the connection between the power supply board 40 and the light source baseboard 30.

The present embodiment further provides a manufacturing method of the aforementioned LED light bulb. The manufacturing method comprises the following steps:

S1: Injection molding of the lampshade: PC transparent plastic material is heated by a horizontal injection molding machine to a temperature of about 270° C. and then injected into a lampshade mold for pressurized injection molding to obtain the lampshade 10.

S2: SMT processing: Apply solder paste or red adhesive on the electronic component mounting position of the power supply board solder pad (including the PCB board), and then adhere the electronic components to their corresponding positions on the power supply board by an automatic mounting machine. The electronic components are then soldered to the power supply board solder pad by reflow soldering to form a semi-finished power supply board. The electronic components and the power supply board solder pad are conventional components whose structures are the same as those of conventional LED light bulbs and are therefore not detailed herein.

S3: Plug-in components processing: Feed the semi-finished power supply board adhered with the electronic components to a plug-in components assembly line; insert two lead wires according to the positions marked by L and N on the PCB board of the semi-finished power supply board, and then put it into a wave soldering furnace for wetting to obtain a power supply board 40.

S4: Semi-finished product inspection: First, visually check whether the surface of the PCB board is clean, whether there is any absent electronic component, and whether wetting of the power supply board solder pad is proper; then put the semi-finished power supply board into a testing fixture for testing.

S5: Soldering two boards: The light source baseboard 30 is placed on the workbench's surface with the LED chip facing downward; the positioning protrusion 42 of the power supply board 40 is pressed into the positioning slot 32 of the light source baseboard 30 according to the polarity indication, and the power supply board 40 and the light source baseboard 30 are tin-soldered firmly.

S6: Power-on test: With a power supply of AC120V 60HZ, perform lighting test using a test probe.

S7: Assembling the lampshade: Align the power supply board 40 and the light source baseboard 30 which are securely connected to each other with the transparent lampshade 10 and assemble the two; remove the rubber cover of the wire on the N-electrode of the power supply board 40, and bend the exposed copper wire from one side of the lampshade 10 to abut against the threaded surface of the transparent lampshade 10; the lampshade 10 is then placed in the fixture with its tip pointed downward.

S8: Copper soldering of solder joint of the threaded opening: Put the base 20 with its threaded opening facing downward on the wire of the L-electrode of the power supply board 40; use an electric iron to wet the solder joint with tin; the solder joint is required to have an arc shape, a smooth surface and without burrs.

S9: Encapsulating glue: Bend the connecting wire of the threaded opening of the base 20 which is soldered with the solder joint, and position it to an automatic glue dispenser with the threaded opening facing upward. When the outlet of the automatic glue dispenser is aligned with the threaded opening, press the machine switch to apply a standard amount of glue (i.e. the sealant 50) to the threaded opening. The standard amount is the same as that of a conventional LED light bulb and therefore will not be detailed herein.

S10: Fastening the threaded opening: Fasten the threaded opening of the base 20 with glue applied thereon to the lampshade according to the screw thread direction and place them to the fixture, and wait for the glue to solidify to obtain a LED light bulb.

S11: Testing the finished product: Visually inspect the appearance of the LED light bulb with solidified glue; check for leakage, whether the threaded opening is in place, and whether there is any residue inside the lampshade; then perform testing with a power supply of AC120V 60 HZ.

The present invention is described in detail above in conjunction with the accompanying drawings, but the present invention is capable of other embodiments and is not limited by the above embodiment. Any variations based on the prior art performed by a person skilled in the art falls within the scope of protection of the present invention.

What is claimed is:

1. A patch LED light bulb comprising a lampshade and a base fixedly connected to the lampshade, characterized in that it further comprises a light source baseboard and a power supply board which are disposed inside the lampshade and electrically connected to each other; the light source baseboard is pasted or soldered with one or more LED chip; the lampshade comprises a cover body and an assembly portion integrally connected to the cover body; the assembly portion is inserted into the base, a limiting slot is provided on the assembly portion; a positioning slot is provided on the light source baseboard; the power supply board abuts against the light source baseboard and is perpendicular to the light source baseboard; the power supply board is integrally connected with a limiting protrusion for inserting to the limiting slot and a positioning protrusion for inserting the positioning slot.

2. The patch LED light bulb as in claim 1, wherein the lampshade is a translucent plastic lampshade.

3. The patch LED light bulb as in claim 2, wherein a plurality of grooves are provided on an outer surface of the cover body; a plurality of protrusions are provided on an inner surface of the cover body at positions corresponding to the grooves.

4. The patch LED light bulb as in claim 1, wherein one end of the assembly portion which is connected with the cover body is integrally connected with a flange; the base abuts against the flange.

5. The patch LED light bulb as in claim 4, wherein the light source baseboard is disposed at a position corresponding to the flange inside the assembly portion.

6. The patch LED light bulb as in claim 1, wherein a sealant is encapsulated between an outer wall of the assembly portion and an inner wall of the base.

7. The patch LED light bulb as in claim 6, wherein the base is a threaded base; an external threaded segment that matches with the threaded base is provided on the assembly portion.
